(19) United States
(12) Patent Application Publication
(10) Pub. No.: US 2013/0071303 A1
(43) Pub. Date: Mar. 21, 2013

(54) MEMBRANE INCUBATION DEVICE

(71) Applicants: Kenneth G. Macnamara, Edinburgh (GB); Stuart Polwart, Banknock (GB); David Barlow, Edinburgh (GB)

(72) Inventors: Kenneth G. Macnamara, Edinburgh (GB); Stuart Polwart, Banknock (GB); David Barlow, Edinburgh (GB)

(73) Assignee: LAB901 LIMITED, Loveland, CO (US)

(21) Appl. No.: 13/699,379

(22) PCT Filed: May 20, 2011
(86) PCT No.: PCT/EP2011/058309

§ 371 Date: Nov. 21, 2012

(30) Foreign Application Priority Data
May 21, 2010 (GB) 1008518.1
Jan. 5, 2011 (GB) 1100094.0

(51) Int. Cl. B01L 1/00; B32B 37/06

(52) U.S. Cl. CPC B01L 1/00; B32B 37/06
USPC 422/500; 156/60; 156/73.1; 29/592

(57) ABSTRACT

A membrane incubation device, wherein the membrane incubation device is adapted to incubate sections of at least one membrane individually.

This application claims the benefit of the filing date of GB1008518.1 filed 21 May 2010 and of GB1100094.0 filed 5 Jan. 2011, the disclosure of which is hereby incorporated herein by reference.

### FIELD OF THE INVENTION

This patent application relates to an improved membrane and membrane incubation device, which are suitable for use in the Western blot analysis method.

### TECHNOLOGICAL BACKGROUND

Western blotting is a labour intensive laboratory analysis method that is widely used in the life sciences to determine whether a target protein is present in a complex sample and to determine the relative quantity of the target protein. The phrase “target protein” is used to refer to a protein that a user of an analysis method wishes to identify within a complex sample. The relative quantity of a protein is used to measure changes in protein expression (i.e. up regulation and down regulation).

Determining whether a particular protein is present is achieved by connecting two variables: the molecular weight of the protein and its immune identity (with the assumption that it is unlikely that these two very different aspects of a protein coexist by chance). Determining the relative quantity of a particular protein is achieved by either measuring the total protein content in the complex sample or by measuring the amount of a “house keeping” protein in the complex sample and then comparing this to the amount of the target protein in the complex sample. The term “housekeeping” protein is used to refer to a common protein involved with basic functioning of a cell, for example beta-actin or tubulin.

The standard western blot method separates the proteins in a complex sample using gel electrophoresis (e.g. sodium dodecyl sulfate polyacrylamide gel electrophoresis, SDS-PAGE), then electro-transfers the separated proteins to a solid membrane (commonly made from nitrocellulose or polyvinylidene fluoride, PVDF) such that the proteins retain the same separation pattern. This membrane is then incubated in diluted protein solutions, e.g. non-fat dry milk or bovine serum albumin (BSA), to block the non-specific binding sites, then incubated with a primary antibody that specifically probes for the target protein. The membrane is then washed and incubated with a secondary antibody that allows for detection of the target protein. This is known as immunodetection.

Often a number of samples are separated in a single gel electrophoresis process, for example using NuPAGE® pre-cast gels for 10, 12, 15, 20 or 26 samples or ScreenTape® wherein up to 16 samples may be run in the 16 sub-containers within a single ScreenTape® (available from Lab901). Incubating each of the multiple samples individually allows each of the samples to be probed with, for example, different types of antibody or different levels of antibody concentration. However, separating the samples to allow them to be probed individually has so far required that they be transferred to separate membranes after the samples have been separated from one another (e.g. by cutting up a single pre-cast gel pre-transfer, or by cutting up a membrane post-transfer, into discrete strips). Clearly this is an awkward, inaccurate and time consuming procedure.

### SUMMARY OF THE INVENTION

Therefore, there may be a need to provide a device suitable for incubating multiple samples individually on the same membrane.

In accordance with a first aspect of an embodiment of the present invention, there is provided a membrane incubation device separated into isolated sections. The isolated sections stop cross-contamination of probes during incubation and allow the required incubation reagents to be separately introduced (e.g. by hand pipetting or by automated means) to each isolated section.

The membrane incubation device of an embodiment of the present invention has many advantages, for example a single membrane incubation device separated into sections allows smaller volumes of incubation reagents to be used. Additionally, enabling the incubations of individual samples with different types of antibody or different levels of antibody concentration enables the optimisation of the probing for a target protein.

The isolated sections of the membrane incubation device may comprise channels created by cutting apertures in a mask to form raised barriers. At least one membrane may be affixed to the mask to provide a membrane incubation device according to an embodiment of the present invention. The mask may be comprised of plastic and may incorporate registration features such that locations on the mask can be mapped back to corresponding registration features on a container used during gel electrophoresis. These reference features assist in the comparison of the results of protein separation and the results of incubation. The mask may be fixed to the surface of the membrane using pressure, for example fastening clips, a clamp system, vacuum, or by a suitable adhesive.

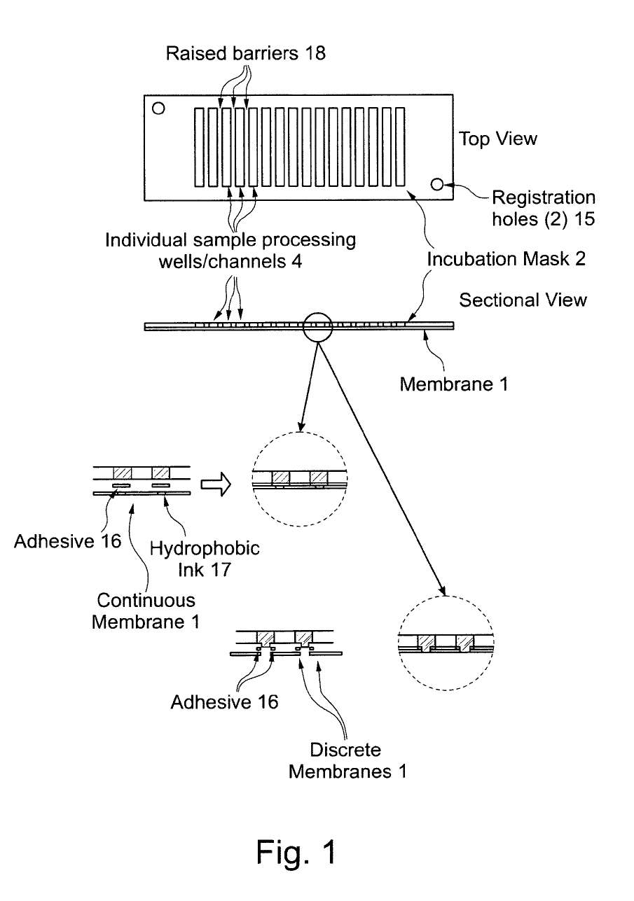

The membrane incubation device of an embodiment of the present invention may also be separated into isolated sections by hydrophobic barriers. The hydrophobic barriers may be used instead of or in addition to a mask which forms raised barriers. The hydrophobic barriers may comprise a glue and/or an ink, which glue and/or ink may be applied by screen printing and may be directly applied to at least one membrane. When hydrophobic barriers are applied to a membrane and this combination is used with a mask the mask may be fixed to the membrane using pressure, for example fastening clips, a clamp system, vacuum, or by a suitable adhesive (FIG. 1). Also, hydrophobic barriers may be applied directly to a mask and this combination fixed to a membrane using pressure, for example fastening clips, a clamp system, vacuum, or by a suitable adhesive.

The at least one membrane affixed to the membrane incubation device may also be isolated into sections by treating the membrane using melting or distorting of the porous structure of the membrane. Sections of membranes, such as PVDF, can be treated using thermal or ultrasonic sealing to produce protein transfer zones. The sealing treatment procedure solidifies the membrane in localised areas such that the treated areas are sealed and fluid and biomolecules are unable to pass through treated areas. These fluid tight barriers prevent the flow (wicking) of fluid from one lane to another such that only untreated areas allow fluid to penetrate the membrane. If fluid is applied to membranes that have not been treated it will spread from the point of contact through the porous material of the membrane leading to cross contamination between sample lanes. The sealing treatment of the membrane prevents this by producing individual zones in which proteins can be transferred which are surrounded by areas impermeable to fluid. Therefore, proteins can be transferred for an electrophoresis gel to the protein transfer zones and each of the protein transfer zones can be treated individually without fluid seeping through the membrane from one sample lane to its neighbouring sample lanes. The protein transfer zones could be designed to align precisely to the isolated sections of the membrane incubation device, whether that is the channels formed by the raised barriers of a membrane mask or hydrophobic barriers placed onto the membrane.

Where the treatment of the membrane is performed using thermal sealing, the membrane would be held under tension and a heating tool shaped to form isolated areas placed over the membrane. Where such a membrane is PVDF, suitable conditions may be temperature of between 190° C. and 220° C., for a time of between 4 to 12 seconds and a force of upwards of 0.5 KgF, preferably the thermal sealing tool might be placed on the membrane at a temperature of 205° C. for seven seconds at a force of 2 KgF.

Where the treatment of the membrane is performed using ultrasonic sealing, a sonotrode, with a contact section having predetermined dimensions, is positioned over a membrane clamped to hold it under tension. The holding of the membrane under tension may be achieved by placing the membrane into a nest (ultrasonic anvil), which has a clamping frame to hold said membrane flat and tensioned. The contact surface bearing the desired pattern can be placed against the membrane and the ultrasonic pulse activated at least once. Where such a membrane is PVDF, said ultrasonic pulse may preferably be activated multiple times for less than 1 second. After application of the ultrasonic pulse the sonotrode can be stopped and the membrane allowed to cool while still being held under tension. Once the treated membrane has been allowed to cool the membrane can be released for use.

One issue particular to sealing of the membrane by heat or ultrasonic treatment is the risk of warping of the membrane due to the local heating at the tool interface, and general heat surrounding the tool being close to the membrane. Warping can be reduced by the application of protective layer prior to welding, typically a 50 to 200 μm paper sheet, although a polymer sheet may also be used. This protective layer acts to help release the heating element from the membrane and distribute the heat more evenly to the treated areas. The process may also include some areas being actively heated while other are actively cooled.

A protective layer that can be used is a paper backer of 50-200 um. Equally, it is possible to use a polymer sheet provided the melt temperature of that sheet was above the melt point of PVDF. Ultrasonic sealing, however, may make any polymer a possibility, as in theory it should only generate heat at the focal point within the PCDF, and should allow joining of dissimilar materials.

In another embodiment the treated sections of the at least one membrane may act as fiduciary markers to aid in alignment procedures during imaging of the membrane and the proteins contained there within.

In one embodiment the at least one membrane used with the membrane incubation device, whether treated or untreated, may incorporate additional reference markers to aid in alignment procedures during imaging of the membrane and the proteins contained there within. Application of the additional alignment features may include, but is not limited to, perforations in the membrane, printing a marker onto a secondary label and subsequently applying this to the membrane, directly printing the marker onto the membrane, or burning a marker into the membrane using heat, ultrasonic heating or a laser.

In another embodiment the at least one membrane used with the membrane incubation device, whether treated or untreated, may incorporate a barcode such that it can enable traceability. This barcode would preferably be resistant to chemicals used in immunodetection such as methanol. Application of the barcode may include, but is not limited to, printing a barcode onto a secondary label and subsequently applying this to the membrane, directly printing a barcode onto the membrane, using a configurable punch tool to create scanable perforations in the membrane or burning a barcode into the membrane using heat, ultrasonic heating or a laser. Additionally, once on the membrane proteins are generally more stable than within an electrophoresis gel, therefore, membranes with an incorporated barcode may be stored for future reference.

In embodiments in which the membrane incubation device comprises a mask, the isolated sections of the mask may be formed by raised barriers that form channels through the mask. The membrane incubation device may comprise multiple membranes, each of which are affixed within one of the channels formed by the raised barriers. The height of the raised barriers may be adjusted to match the combined thickness of the at least one membrane and an adhesive layer. The channel formed by the raised barriers may be shaped in order to aid loading of fluids. The shaping of the channels may vary, for example, squares, circles, ovals or even reminiscent of tadpoles such that the wider more circular end forms a loading port such that it is more accessible for a pipette tip letting the fluid flow to the narrower end. The shape of the adjacent wells may be the same shape in the opposite orientation to allow a large number of lanes to be positioned side by side and easily and accurately loaded using a standard pipette.

In another embodiment in which the membrane incubation device comprises a mask with channels, the membrane incubation device may also contain fluid tight deformable seals at the interface with the membrane, for example gaskets. The said fluid tight deformable seals may be positioned such that they aid the formation of fluid tight seals around the edges of the channels cut into the membrane mask. This may include the seal being attached to the membrane or attached to the incubation device. Where the fluid tight deformable seal is a gasket the gasket may form a number of shapes to fit the exact dimensions of the channels, one example of such a gasket might include an O-ring. Where the fluid tight deformable seal is a gasket it may have a hardness of between 25 and 75 Shore A, but would more typically be between 30 to 50 Shore A. In the preferred embodiment a gasket may have a hardness of between 35 to 40 Shore A.

In embodiments where the membrane incubation device contains fluid tight deformable seals, such as gaskets, the fluid tight deformable seals, which are the exact dimensions of the channels in the membrane mask, could also be the exact dimensions of the protein transfer zones in the at least one membrane treated to create areas impermeable to fluid. For example, the fluid tight deformable seals surrounding the channels of the membrane mask could be positioned over the areas around the protein transfer zones which have been treated to make them impermeable to fluid. The combination of the fluid tight deformable seals and areas of the membrane made impermeable to fluid would enable lanes to be treated individually and prevent cross contamination between lanes. Ensuring dimensions of the channels, fluid tight deformable seals and areas of the membrane treated to be impermeable to fluid are all precisely configured would be critical to formation of the fluid tight seals around the protein transfer zones.

In another embodiment in which the membrane incubation device comprises a mask, the membrane incubation device could also include a contact transparency feature wherein the feature is opaque when dry and transparent when wetted. An additional element may include the revealing of a colour under the feature after it has become transparent. This feature will aid the user to easily determine which wells have, and well have not, been in contact with fluid i.e. solutions containing antibodies. The contact transparency feature may be reusable such that when dried it returns to being opaque.

In another embodiment in which the membrane incubation device comprises a mask, the membrane incubation device may contain an overflow area such that each lane can be addressed individually for small volumes or a larger volume can be used to flood all lanes such that each lane is incubated with the same sample.

In embodiments in which the membrane incubation device comprises a mask, the membrane may be held between a first surface, being the membrane mask, and a second surface, being a support surface for the membrane. The membrane mask, forming the first surface, and the support surface, being the second surface, may contain means to secure the at least one membrane between the two surfaces. The securing means could include, but are not limited to, fastening clips or a clamp system. The said securing means may be used to hold the membrane under tension between the two surfaces. Holding the membrane under tension in the membrane incubation device creates a flat and smooth surface for further processing of the membrane such as during the incubation procedures necessary for western blot analysis.

In embodiments where the membrane is held between a membrane mask and a support surface, the said support surface may also contain channels. The channels of the support surface may align to the channels in the membrane mask. The channels of the support surface may also contain fluid tight deformable seals. The fluid tight deformable seals of the support surface may also align perfectly with the fluid tight deformable seals of the membrane mask. For example, the membrane mask and the second surface may both contain channels lined with gaskets to form a fluid tight seal when the said gaskets are positioned on the upper and lower surfaces of a membrane. Additionally, the dimensions of the fluid tight deformable seals on the support surface could be the exact dimensions of the protein transfer zones in at least one membrane treated to create areas impermeable to fluid.

In embodiments where the membrane is positioned between a membrane mask and a support surface, a treated membrane, which contains area impermeable to fluid surrounding protein transfer zones, would be positioned over the fluid tight deformable seals which run around the channels of the support surface. The membrane mask could then be positioned over the membrane and the apertures of the membrane mask aligned with the protein transfer zones such that when the membrane mask and second surface are secured the fluid tight deformable seals on the upper and lower surfaces of the membrane are positioned on the fluid sealed sectioned of the membrane to form a fluid tight conduit around the protein transfer zones. In another embodiment of the membrane incubation device, the membrane mask and the support surface are associated with an apparatus for improving incubation when using a membrane incubation device. In such an embodiment the membrane mask may be a removable feature of the incubation apparatus and/or the support surface may be a removable feature of the incubation apparatus. Alternatively, in such an embodiment the membrane mask may be an integrated feature of the incubation apparatus and/or the support surface may be an integrated feature of the incubation apparatus.

In another embodiment the incubation apparatus may also include a vacuum system such that fluids placed into the channels of the membrane mask are sucked through the membrane under vacuum. The channels formed by the membrane mask and support surface allow the membrane sandwiched between them to be exposed to negative pressure of up to 100 kPa, but preferably between 15 to 45 kPa. The membrane incubation device may also contain a means to turn the vacuum on and off. Also, the membrane incubation device may contain means to vent the vacuum to release the pressure on the membrane. In addition, the membrane incubation device may contain means to regulate the vacuum to a greater or lesser extent or even stepped or pulsed. This provides a quick and efficient methodology of removing samples from the membrane while, at the same time, increasing the penetration of the fluid into the membrane. In another embodiment the means to create a vacuum could also be used to dry the membrane after completion of the incubation step of immunodetection and prior to imaging of the membrane.

In another embodiment the incubation apparatus may include a removable waste container positioned below the membrane. The removable waste container may have a handle or other means to allow access to the container so that it can be removed and emptied with ease.

In embodiments where the membrane incubation device comprises a mask, the mask and/or incubation apparatus could be made from styrenics, acrylics, or polycarbonate. Also, in areas where high surface energy may cause fluid flow problems, such as retaining moisture on the side-walls, a lower surface energy polymer, such as polypropylene could be used. A further important consideration is that the plastic materials must not absorb/bind proteins i.e. the antisera in the incubation solutions.

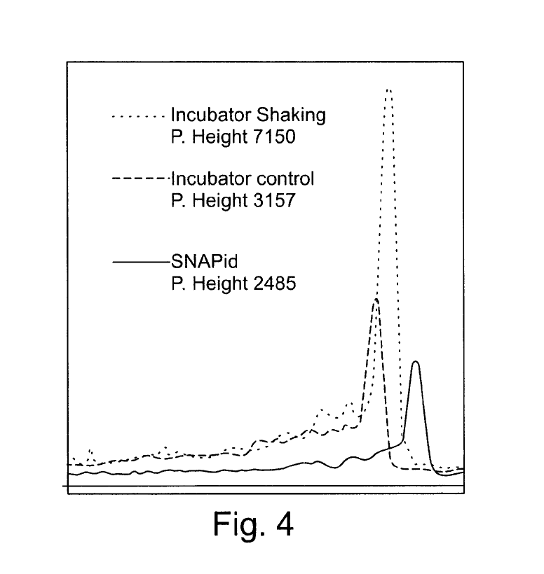

In another embodiment the membrane incubation device could include means to improve incubation of a sample on a membrane by mechanical diffusion such as mixing, vortexing/vibrating, sonic waves, controlling the speed of vacuum applied pulling the solution through the membrane, pulling the sample back and forth through the membrane under pressure. For example, shaking of the membrane device can allow fluids to permeate through the porous membrane increasing the contact of the incubation fluids, such as solutions containing antibodies, with the embedded proteins. FIG. 4 shows that in embodiments where a membrane treated to form fluid impenetrable zones is used in conjunction with the membrane incubation device shaking increases diffusion and the opportunity for the primary antibody to come into contact with the target protein or the secondary with the primary.

An embodiment of this invention allows for the use of an immunoassay to be focused over a much smaller area than a traditional slab gel such that the sample volume can be significantly reduced and sensitivity is improved. Therefore, an embodiment of this invention will be more efficient both in time and cost than traditional methods.

The membrane incubation device of an embodiment of the present invention can readily be made compatible with, for example, the Millipore SNAP i.d.® device (for incubation) and the Lab901 TapeStation® (for post blotting and/or post transfer imaging).

In an embodiment, a membrane device is provided which membrane device is separated into isolated sections.

### DETAILED DESCRIPTION OF EXEMPLARY EMBODIMENTS

For fuller understanding of the nature of the objects of an embodiment of the present invention, reference should be made to the following drawings in which the same reference numerals are used to indicate the same or similar parts wherein:

FIG. 1 shows one embodiment of the membrane incubation device in contact with a membrane.

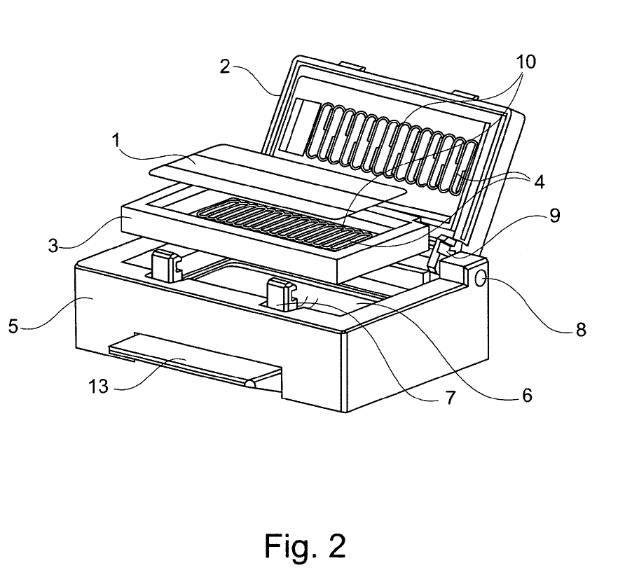

FIG. 2 shows a second embodiment of the membrane incubation device, wherein the membrane incubation device forms part of an incubation apparatus.

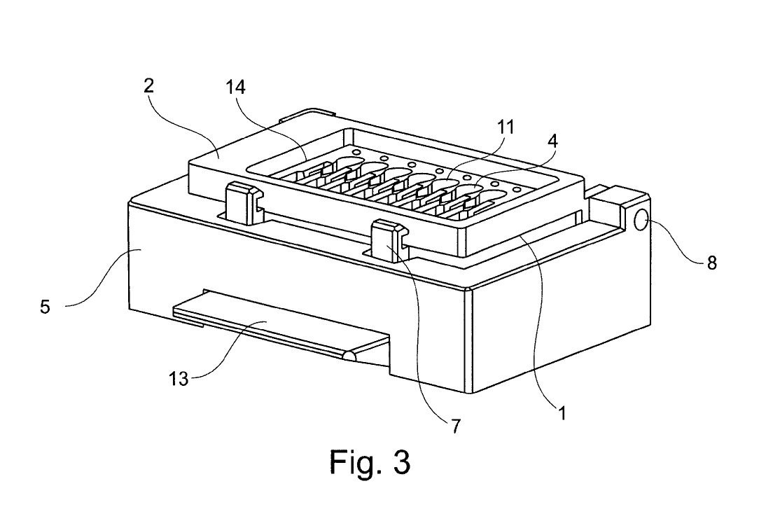

FIG. 3 shows the assembled membrane incubation device as part of an incubation apparatus.

FIG. 4 shows a comparative analysis of the improvement provided by shaking using the Snap id system with no shaking, the Lab901 system with no shaking, and the Lab901 system with shaking

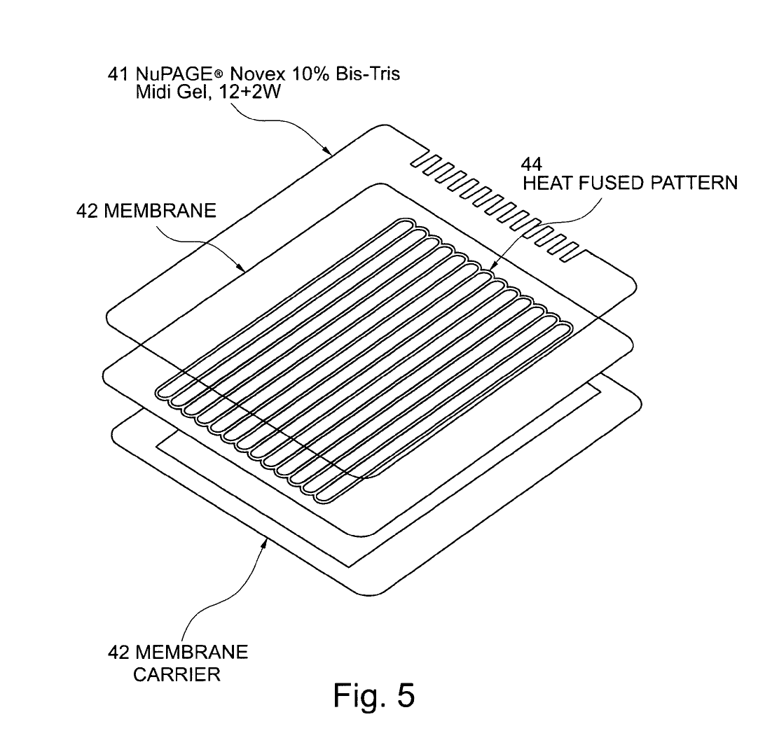

FIG. 5 shows a NuPage® Midi Gel with 14 lanes positioned over a membrane which has been cut to fit the same dimensions as the NuPage® gel (8×13 cm) and has undergone treatment to form protein transfer zones surrounded by area impermeable to fluid.

FIG. 1 shows a membrane mask 2 positioned over a membrane 1. The registration mask 2 contains registration holes 15. In one embodiment of the invention the membrane mask 2 is positioned over a continuous membrane 1 and affixed to the membrane using an adhesive 16. The continuous membrane 1 is separated into discrete sections using a hydrophobic ink 17. The purpose of the hydrophobic ink 17 being to create fluid tight barriers between different section of the membrane 1. The channels 4 of the membrane mask 2 fit over the sections of the continuous membrane containing protein and raised barriers 18 sitting over the parts of the membrane blocked by hydrophobic ink 17. In another embodiment of the invention the membrane mask 2 is positioned over discrete sections of membrane 1 wherein the channels 4 of the membrane mask 2 are positioned over the membranes 1 and the membrane 1 is held in place by adhesive 16.

FIG. 2 shows an incubation apparatus 5 consisting of a membrane 1 which is precisely positioned onto a removable membrane support 3 (such that the transferred proteins on the membrane align precisely with the wells). The removable membrane support surface 3 contains channels 4 with gaskets 10 around the edge of said channels 4. The removable membrane support surface 3 is positioned into a recess in the incubation apparatus 5 which sits above a removable waste container which sits beneath a plenum 6 which collects the waste and funnels it down to the waste container which extends from the membrane incubation device 5. Attached to the incubation apparatus 5 by a hinge 8 is a membrane mask 2 which can be lowed using the hinge 8 over the membrane 1. As the membrane mask 2 is swung over the membrane 1 the support surface is fixed in place by the support surface securing means 9. The membrane mask 2 is locked into position using fastening clips 7. The membrane mask 2 contains channels 4 which align precisely with the channels 4 in the membrane support surface 3. The fastening clips 7 can be opened using release catch 13 to allow the membrane 1, membrane mask 2 and membrane support surface 3 to be removed after use.

FIG. 3 shows the membrane incubation device in a closed position with the membrane mask 2 fastened into place over a membrane 1 using the fastening clips 7. The upper portion of the membrane mask 2 shows the channels 4 which form raised barriers 18 and are shaped to form loading ports 11 for easy loading to the channels 4 as well as the overflow area 14 surrounding the channels 4 for adding a large volume of fluid to all the channels 4 at once. The fastening clips 7 can be opened using release catch 13 to allow the membrane 1, membrane mask 2 and membrane support surface 3 to be removed after use.

FIG. 5 shows a NuPage® Midi Gel with 14 lanes 41 positioned over a membrane 42 which has been cut to fit the same dimensions as the NuPage® gel (8×13 cm) and has undergone treatment to form protein transfer zones surrounded by area impermeable to fluid 44. The heat fused pattern of protein transfer zones 44 corresponds precisely with the 14 lanes of the NuPage® Midi gel. The membrane is positioned upon a membrane carrier 43.

### EXAMPLE 1

Membranes containing individual protein transfer zones can be manufactured by:
a) Sections of a PVDF membrane covered in a protective material, typically a paper backer or polymer sheet between 50 to 200 μm in thickness, were placed into an ultrasonic anvil.
b) The membrane was secured in the ultrasonic anvil using a clamp to hold the membrane under tension.
c) A sonotrode with machined raised features at the contact surface to focus the ultrasonic vibrations was pressed against the protective layer covering.
d) The ultrasonic pulse was activated to locally seal the membrane at the raised focus features of the sonotrodes contact surface.
e) The membrane was allowed to cool and the sonotrode removed

### EXAMPLE 2

### Use of the Membrane Incubation Device as Part of a Western Blot Analysis Using LAB901 Western Blot Apparatus

### Gel Electrophoresis

A sample comprising proteins was prepared as follows:
a. Incubating a 2 μl protein sample with 2 μl fluorescent stain at 75° C. for 7 minutes;
b. Adding 4 μl of a loading buffer, mixing and incubating again at 75° C. for 5 minutes; and
c. Adding 2 μl of in-lane marker.

The samples were loaded onto a Lab901 P200 ScreenTape® electrophoresis gel and run according to the manufacturer's standard protocol to separate the proteins. The used ScreenTape® was imaged using the Lab901 TapeStation®.

Transferring the Separated Samples onto Membranes

The used ScreenTape® comprising the separated proteins was recovered from the TapeStation®, its carrier layer was removed and two blades were used to cut away the top and bottom of the ScreenTape® exposing the top and bottom of the gel columns contained within 16 sub-containers. A comb comprising 16 gel pushing elements was used to push against the gel within each of the sub-containers such that the gel was extracted onto a PVDF membrane that had been soaked in tris-glycine 20% methanol transfer buffer. The membrane having individual protein transfer zones created by prior heat treatment of the PVDF membrane. The membrane was located on top of a sheet of blotting paper that had also been soaked in tris-glycine 20% methanol transfer buffer, with both the blotting paper and the membrane supported on an anode plate. A second sheet of blotting paper that had been soaked in tris-glycine 20% methanol transfer buffer was placed on a cathode plate and the cathode plate closed onto the anode plate, and the proteins were transferred at a voltage of 50 V/cm for 10 minutes. The blotting papers and gel were removed from the membrane. The gel remained associated with the blotting paper post-transfer and lifting off cleanly from the membrane.

### Quality Control Step

Post-transfer the membrane was imaged using the Lab901 TapeStation®. The total protein image recorded following electrophoresis was superimposed upon the image of total protein transferred to the membrane using fiduciary markers and alignment features. The efficiency of the transfer process was then assessed before proceeding with the immunodetection process. Following this analysis the membrane was then transferred to the antibody incubation device.

### Probing the Separated and Transferred Samples

The separated proteins on the membranes were transferred to an incubation apparatus, as follows:
a) The membrane composed of individual protein transfer zones surrounded by fluid impermeable sections, was relocated to a support surface containing channels measuring the exact dimensions of the individual protein transfer zones;
b) the membrane was positioned onto the support surface such that perfect alignment was achieved;
c) the support surface was placed into an incubation apparatus atop a removable waste container;
d) the membrane was then secured using an upper mask which fits over the support surface, the mask containing channels measuring the exact dimensional of the individual protein transfer zones.
e) The vacuum supply was then connected to the incubation apparatus.

Immunodetection was then used to probe the membrane as follows:
a. Blocking the non-specific binding sites using 0.05% non-fat dry milk (NFDM) in phosphate-buffered saline Tween (PBST), which was removed by vacuum aspiration;
b. Primary antibody incubation: anti-lysozyme at 1:1000 concentration and incubating for 10 minutes, which was removed by vacuum aspiration;
c. Washing 3× with PBST, which was removed by vacuum aspiration;
d. Secondary antibody incubation: Goat anti-Rabbit IgG-Alexa488 at 1:10,000 concentration and incubating for 10 minutes, which was removed by vacuum aspiration;
e. Washing 3× with PBST, which was removed by vacuum aspiration;
f. a vacuum was applied to the membrane until it was dry;
f. the membranes was removed from the incubation apparatus; and
g. imaged on the TapeStation®.

GeneTools® for Lab901 software was used to overlay the profiles for the separated proteins post-electrophoresis and post-transfer and the probed proteins using the alignment features and fiduciary markers present on the ScreenTape® and heat treated PVDF membranes.

### EXAMPLE 3

Use of the membrane incubation device for immunodetection of proteins separated by electrophoresis using proteins separated using an Invitrogen™ NuPAGE® 12 lane electrophoresis gel.
a) Post electrophoresis using the NuPAGE® gel system, a membrane, treated using thermal or ultrasonic sealing to form 12 lanes protein transfer zones which correspond exactly to the dimensions of the 12 lanes of the NuPAGE® electrophoresis gel, was used in a protein transfer process (see FIG. 5).
b) Post transfer the transfer apparatus was disassembled and the membrane composed of individual protein transfer zones surrounded by fluid impermeable sections, was relocated to a support surface containing channels measuring the exact dimensions of the individual protein transfer zones;
c) the membrane was positioned onto the support surface such that perfect alignment was achieved;
d) the support surface was placed into an incubation apparatus atop a removable waste container;
e) the membrane was then secured using an upper mask which fits over the support surface, the mask containing channels measuring the exact dimensional of the individual protein transfer zones.
f) The vacuum supply was then connected to the incubation apparatus.

Immunodetection was then used to probe the membrane as follows:
a. Blocking the non-specific binding sites using 0.05% non-fat dry milk (NFDM) in phosphate-buffered saline Tween (PBST), which was removed by vacuum aspiration;
b. Primary antibody incubation: anti-lysozyme at 1:1000 concentration and incubating for 10 minutes, which was removed by vacuum aspiration;
c. Washing 3×with PBST, which was removed by vacuum aspiration;
d. Secondary antibody incubation: Goat anti-Rabbit IgG-Alexa488 at 1:10,000 concentration and incubating for 10 minutes, which was removed by vacuum aspiration;
e. Washing 3× with PBST, which was removed by vacuum aspiration;
f. a vacuum was applied to the membrane until it was dry;
f. the membranes was removed from the incubation apparatus; and
g. imaged on the TapeStation®.

GeneTools® for Lab901 software was used to overlay the profiles for the separated proteins post-electrophoresis and post-transfer and the probed proteins using the alignment features and fiduciary markers present on the ScreenTape® and heat treated PVDF membranes.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

1. A membrane incubation device, wherein the membrane incubation device is adapted to incubate sections of at least one membrane individually.

2. A membrane incubation device according to claim 1, wherein the membrane incubation device comprises a mask and at least one membrane.

3. A membrane incubation device according to claim 1, wherein the membrane incubation device is separated into isolated sections by hydrophobic barriers.

4. A membrane incubation device according to claim 2, comprising isolated sections formed by channels, wherein the channels are formed by raised barriers of the mask, and wherein at least one membrane is located within each of the channels.

5. (canceled)

6. A membrane incubation device according to claim 4, wherein the mask contains an overflow area formed around the channels.

7. A membrane incubation device according to claim 4, wherein the membrane incubation device includes a contact transparency feature which is opaque when dry and transparent when wetted.

8. (canceled)

9. A membrane incubation device according to claim 4, wherein the isolated sections formed by channels are associated with fluid tight deformable seals at the interface with the membrane forming a fluid tight seal around the channels.

10.-13. (canceled)

14. A membrane incubation device according to claim 3, wherein the hydrophobic barriers comprise a material selected from the group consisting of a glue, an ink, and both a glue and an ink.

15. (canceled)

16. A membrane incubation device according to claim 1, wherein the membrane sits on a membrane support surface.

17. A membrane incubation device according to claim 16, wherein the membrane support surface is separated into isolated sections.

18. A membrane incubation device according to claim 17, wherein the isolated sections are formed by raised barriers to form channels.

19.-57. (canceled)

58. A method of manufacturing membranes, wherein the membrane is separated into isolated sections.

59. A method of manufacturing membranes according to claim 58, wherein the membrane separated into isolated sections has been treated to create areas of the membrane impermeable to fluid.

60. A method of manufacturing membranes according to claim 59, wherein the isolated sections are surrounded by areas of the membrane impermeable to fluid to create protein transfer zones.

61. A method of manufacturing membranes according to claim 60, wherein the protein transfer zones are designed to align precisely to the dimensions of channels in a membrane incubation device.

62. A method of manufacturing membranes according to claim 60, wherein the membrane was treated to create protein transfer zones surrounded by the areas impermeable to fluid using thermal sealing or ultrasonic sealing.

63.-68. (canceled)

69. A method of manufacturing membranes according to claim 62, wherein the treatment is performed through a protective layer.

70. (canceled)

71. A method of manufacturing membranes according to claim 62, wherein the treatment includes some areas being actively heated while other areas are actively cooled.

72.-77. (canceled)

78. A membrane separated into isolated sections by areas of the membrane treated to be impermeable to fluid.

79. A membrane according to claim 78, wherein the isolated sections are surrounded by areas of the membrane impermeable to fluid to create protein transfer zones.

80.-83. (canceled)
